(19) United States
(12) Patent Application Publication
(10) Pub. No.: US 2015/0317067 A1
(43) Pub. Date: Nov. 5, 2015

(54) SYSTEM AND METHOD FOR INTERACTING WITH A USER

(71) Applicant: Pheebo, Inc., Rancho Cucamonga, CA (US)

(72) Inventor: Arthur MATIOSSIAN, Rancho Cucamonga, CA (US)

(21) Appl. No.: 14/700,043

(22) Filed: Apr. 29, 2015

Related U.S. Application Data
(60) Provisional application No. 61/986,755, filed on Apr. 30, 2014.

(51) Int. Cl. G06F 3/0484; G06F 3/0481

(52) U.S. Cl. CPC G06F 3/04842; G06F 3/04817

(57) ABSTRACT

A method for presenting content for a plurality of channels on a screen of a device. The method includes: determining whether or not each of the plurality of channels is available for preview; determining an available resource for each of the plurality of channels; displaying a less resource-intensive visual item for each of the plurality of channels until the channel becomes available for preview and the available resource assigned to the channel is above a threshold; and replacing the less resource-intensive visual item with a resource intensive visual item.

This application claims the benefit under 35 U.S.C. §119(e) of U.S. Provisional Patent Application No. 61/986,755, filed Apr. 30, 2014, the contents of which are incorporated by reference herein in its entirety for all purposes.

### FIELD

The present invention relates generally to presenting content on a user interface, and more particularly, to systems and methods of aggregating media content from different content sources and offering the aggregated content for previewing and selection on a visual user interface.

### BACKGROUND

Content including multimedia content is widely-available on the Internet. A user can browser and locate different content such as video clips from multiple websites. However, each individual website may not offer all categories of content that may be of interest to the user. This requires the user to visit different websites to access content made available by different content providers. Furthermore, various content (e.g., video clips) offered for selection on a screen (e.g., a main menu screen of a website) is typically presented in a static manner that may not provide sufficient information regarding the content to the user.

### SUMMARY

This generally relates to aggregating content from various sources on the network and presenting the aggregated content in a live, intelligent, and dynamic way on client devices. As will be detailed in the embodiments below, the systems and methods of this disclosure can include a server capable of connecting to various content providers over a network. The server can manage and direct content from multiple channels offered by the content providers to various client devices. The server can include a preview manager configured for dynamically providing visual resources to be displayed on the client devices via a client-side application. The visual resources can be presented in different forms depending on, for example, the available network resources and hardware/software resources available to the content providers and/or the client devices. The visual resources can include, for example, video previews and/or static images based on the available resources. Accordingly, the display interface on a client device can be showing video previews/clips of the content for some of the channels, but static images of individual frames for other channels. As more (or less) resources become available to each channel, the corresponding visual presentation on the client can also change back and forth between video and image, creating a matrix effect.

### BRIEF DESCRIPTION OF THE DRAWINGS

FIG. 1 illustrates an exemplary network, according to an embodiment of the disclosure.

FIG. 2 illustrates the exemplary components of a computer system, according to embodiments of the disclosure.

FIG. 3 illustrated the exemplary steps in a method of producing user interface items (e.g., previews) based on the resources available to each of the available channels, according to embodiments of the disclosure.

FIGS. 4a, 4b, and 5 illustrate exemplary screen shots on a client device, according to an embodiment of the disclosure.

FIG. 6 illustrates exemplary ways of a user interacting with a device, according to an embodiment of the disclosure.

### DETAILED DESCRIPTION

In the following description of preferred embodiments, reference is made to the accompanying drawings which form a part hereof, and in which it is shown by way of illustration specific embodiments in which the disclosure can be practiced. It is to be understood that other embodiments can be used and structural changes can be made without departing from the scope of the embodiments of this disclosure.

This generally relates to aggregating content from various sources on the network and presenting the aggregated content in a live, intelligent, and dynamic way on client devices. As will be detailed in the embodiments below, the systems and methods of this disclosure can include a server capable of connecting to various content providers over a network. The server can manage and direct content from multiple channels offered by the content providers to various client devices. The server can include a preview manager configured for dynamically providing visual resources to be displayed on the client devices via a client-side application. The visual resources can be presented in different forms depending on, for example, the available network resources and hardware/software resources available to the content providers and/or the client devices. The visual resources can include, for example, video previews and/or static images based on the available resources. Accordingly, the display interface on a client device can be showing video previews/clips of the content for some of the channels, but static images of individual frames for other channels. As more (or less) resources become available to each channel, the corresponding visual presentation on the client can also change back and forth between video and image, creating a matrix effect.

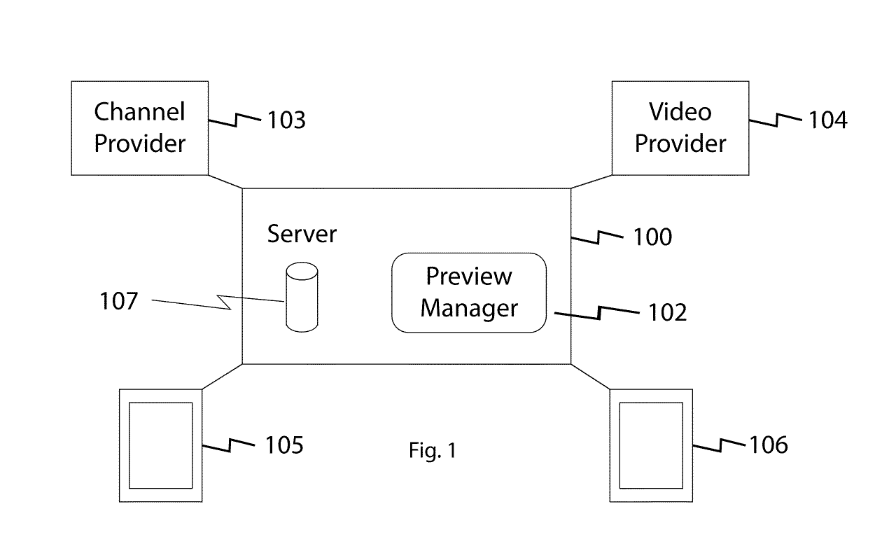

FIG. 1 illustrates an exemplary network, according to an embodiment of the invention. The network can include, for example, a server 100 connected to a channel provider 103, video provider 104, and client devices 105, 106. The channel provider 103 and video provider 104 can be third party content providers such as Reddit and YouTube. The channel provider 103 can provide one or more channels of video content. Each channel can be dedicated to a specific show (e.g., a Sesame Street channel) or have a general theme (e.g., a sports channel or an educational channel). In some embodiments, the channels can be a personalized channel (e.g., a YouTube channel created by a user). The video provider 104 can be a video repository such as a video sharing website that provides access to individual video clips. Although only one channel provider 103 and one video provider 104 are shown in FIG. 1, it should be understood that more than one channel provider 103 and/or video provider 104 can be connected to server and provide content to the client devices 105, 106.

The client devices 105, 106 can be any electronic/computing devices capable of connecting to a network and obtaining content from various sources on the network. For example, client device 105 can be a tablet PC. Client device 106 can be a smartphone. Other examples of the client devices include, for example, a personal computer (PC), Mac, electronic reader, smart TV, etc. The client devices 105, 106 can be running on any suitable operating systems such as Windows, Android, Mac OS, iOS, Linex, etc. One or more software applications can be installed on the client devices 105, 106 for receiving and displaying content including multimedia content. Although FIG. 1 only shows two client devices 105, 106, it should be understood that any number of client devices can be connected to the server 100.

The above-described devices including the channel provider 103, video provider 104, and client devices 105, 106 can be connected to the server 100 via a computer network. The computer network can be any existing network including, but not limited to, a local area network (LAN), wide area network (WAN), cellular network, WiFi network, and other wireless networks suitable for transmitting and receiving content. In some embodiments, the network can be a public network such as the internet. In other embodiments, the network can be a dedicated network (e.g., a virtual private network (VPN)). The network can provide a fixed or variable bandwidth for transmitting data including different types of content among the devices of FIG. 1.

The server 100 can be configured for managing the channels/feeds from the channel provider 103 and/or video provider 104. In one embodiment, various channels/videos from one or more channel provider 103 and video provider 104 can be centrally stored on the server 103 where they can be dynamically controlled. The server can include a database 107, which can contain, for each channel, fields pertaining to, for example, the display title, display order, associated metadata such as category tags and channel type, and fields related to the visual presentation such as the preview images, preview videos, and avatars as well as fields describing the contents of the channel such as user names, channel names, RSS feeds, and other URL resources. It should be understood that the fields in database 107 are not limited to those listed above and one or more of the fields listed above can be optional.

The channel/video content serviced by the server 100 can include, but is not limited to, channels/videos provided by channel provider 103 and video provider 104, as well as social media content such as Facebook and Twitter. Channel content can encompass a variety of form such as web pages, purchasable content such as iTunes, or even advertising media such as banner, video, or other promotional material. In one embodiment, the server 103 can itself be a content provider that provides, for example, video or audio content. The content provided by the server 103 can be original content not available on any other content sources or 3^{rd} party content. The server 103 can also serve as an advertisement server for providing various personalized ads to each client devices 105, 106.

In the embodiment illustrated in FIG. 1, the server can include a preview manager 102 for dynamically providing previews of the content offered by the channel provider 103 and video provider 104. In one embodiment, through the use of periodic updates, the preview manager 102 can attempt to load various forms of visual resources in order to present a dynamic informative overview of available content on the user devices 105, 106. All channels/videos may not be necessarily previewing. The preview manager 102 can be the centralized resource that tracks which channels and/or videos are on the screens of the client devices 105, 106 and which channels and/or videos are not, thereby optimizing the utilization of the limited hardware resources. The preview manager 102 can maintain and recycle a queue of available hardware resources that can be utilized for generating a dynamically-updated user interface (e.g., the matrix effect as detailed below) for the client devices 105, 106.

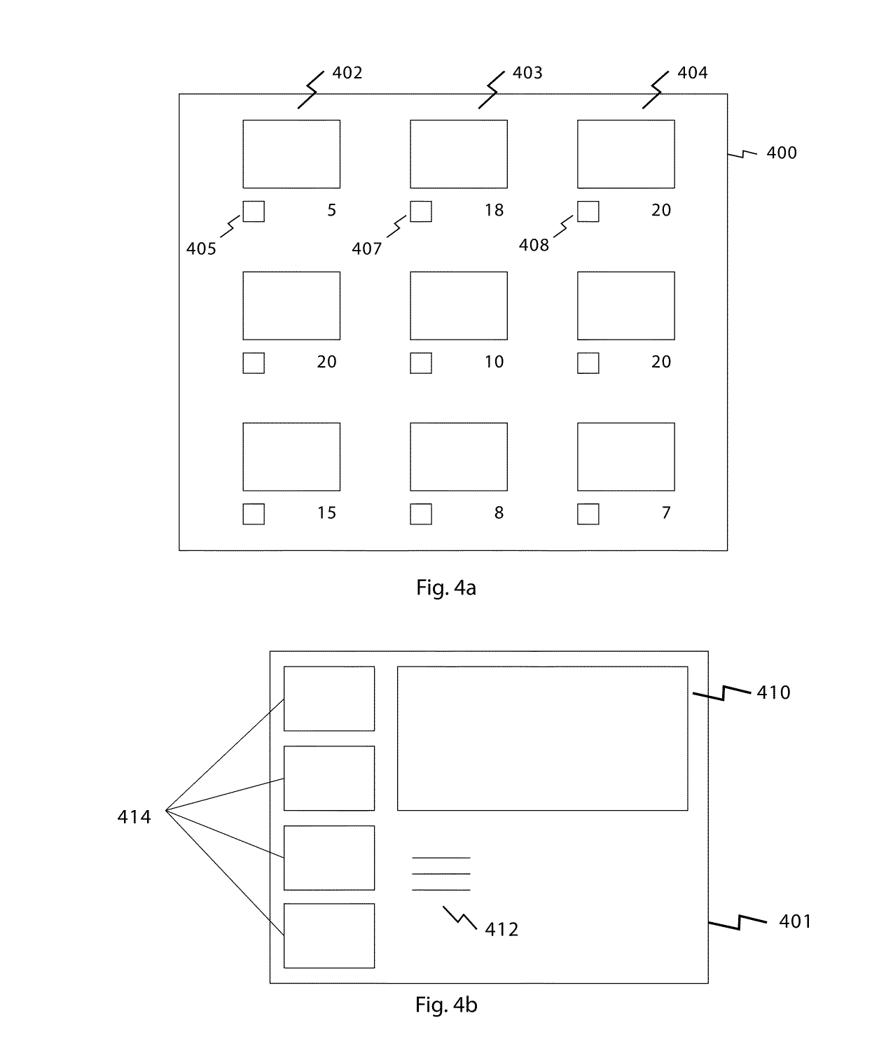

In some embodiments, the preview manager can reside on a client instead of the server. In these embodiments, each client can communicate directly with the channel providers and/or video providers and manage the visual resources locally. Additionally, in some embodiments, where the preview manager operates can fluctuate depending on the abilities of the client device. Simple devices such as digital media players may be occupied only with the presentation of the content, with the workflow (e.g., the steps shown in FIG. 3) occurring on the server, as illustrated in FIG. 1. More sophisticated devices such as smartphones may encompass both the workflow and the content presentation.

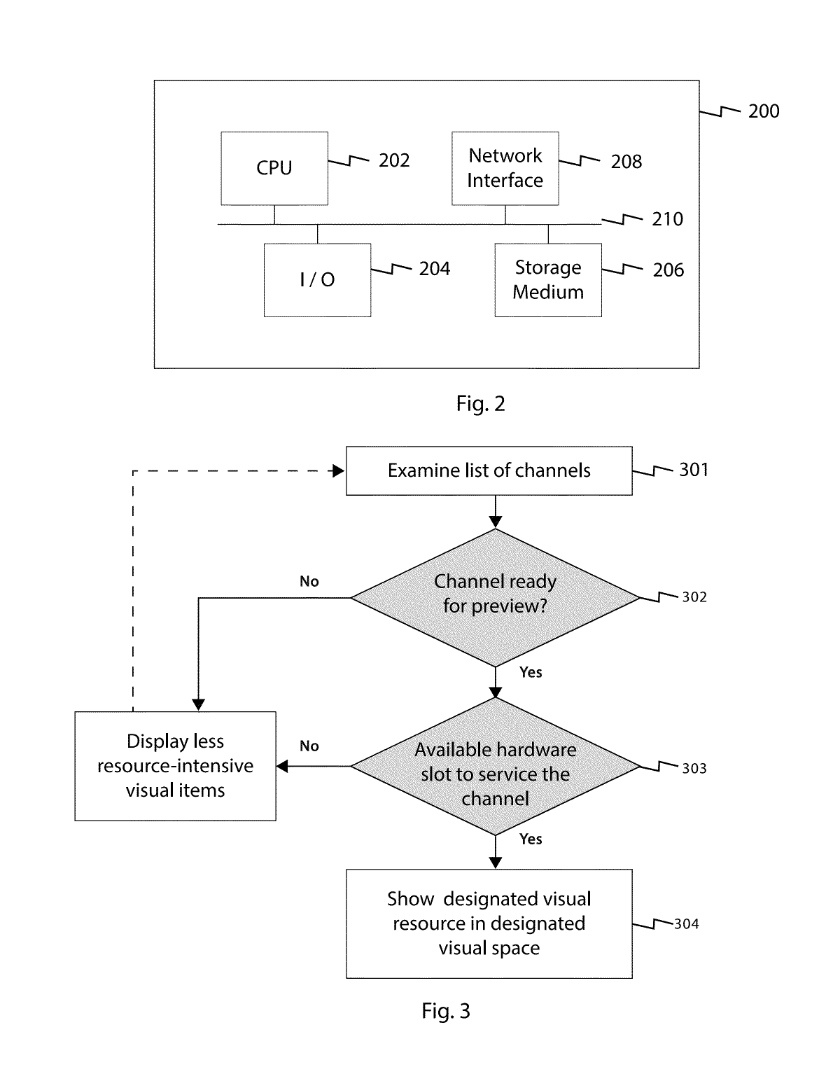

Each of the server 100, channel provider 103, video provider 104, and client devices 105, 106 of FIG. 1 can be a computer device 200 that includes common hardware components illustrated in FIG. 2. As illustrated, the device 200 can include a central processing unit (CPU) 202, I/O 204, storage medium 206, and network interface 208, all of which can be connected to each other via a system bus 210. The network interface on each of the server 103, channel provider 103, video provider 104, and client devices 105, 106 can allow the device to be connected to one or more of the other devices on a shared network and enable the various devices to transmit and receive data from each other.

Depending on whether the device 200 is the server 100, channel/video provider 103, 104, or client devices 105, 106, one or more of functions of the device can be performed by the components illustrated in FIG. 2 via software programs stored in the storage medium 206 of the computer 200 and executed by the processor 202. In various embodiments, one or more of the functions can be performed by software, hardware or a combination of hardware and software.

In some embodiments, one or more programs running on the server 100, channel provider 103, video provider 104, or client devices 105, 106 can be stored and/or transported within any non-transitory computer-readable storage medium, such as the storage medium 206 of FIG. 2, for use by or in connection with an instruction execution system, apparatus, or device, such as a computer-based system, processor-containing system, or other system that can fetch the instructions from the instruction execution system, apparatus, or device and execute the instructions. For example, the database 107 and/or the preview manager 102 on server 100 can, for example, be stored in the storage medium 206 of computer 200.

In the context of this document, a “non-transitory computer-readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

FIG. 3 illustrated the exemplary steps in a method of producing user interface items (e.g., previews) based on the resources available to each of the available channels. In this embodiment, first, the preview manager can periodically examine the list of channels that have requested previewing (step 301) and determine whether there is an channel that is ready to preview (step 302). As discussed above, the preview manager can be either on a server to affect global changes or on the client devices to affect more targeted marketing or user preferences. When at least one channel is ready, the preview manager can determine whether there is an available hardware slot to service that channel (step 303). If so, the preview manager can begin showing the designated visual resource in the designated visual space (step 304). For example, the visual resource can be a video clip previewing the content. The video clip can be streamed from the channel provider or video provider to the client device. Because the video clip can be relatively large in size and require a minimum amount of network bandwidth and/or processing power on the channel/video providers and/or client device to be presented in the optimal resolution and/or speed, the preview manager can hold off pushing the video clip to the client when these required sources are not yet available.

When the channel is not ready or there are no resources available to service the request, the preview manager can fall back on less resource intensive visual items such as static images (step 305). For example, instead of showing the video preview on the receiving client device, the preview manager can simply display a static image (e.g., a frame from the video or a title screen) on the client device. Alternatively, the preview manager can display a number of images in a fixed or random order. The images can typically require less network and hardware resources to transmit and display. In some embodiments, the images can be pre-downloaded and stored on the same server where the preview manager resides. The static image(s) can be displayed until the preview manager detects enough resources available to show the video clip associated with the same content.

In another embodiment, throughout the process, the preview manager can also monitor the states of the channels. Given the indefinite nature of loading resources over the network, there can be a high variability in the availability of visual resources such as images and videos for the channel, the provider, the content, the avatar, etc. The preview manager can also monitor the availability of these items, and when appropriate, when a particular resource for a channel does become available, a suitable animation can be used to visually present this new information to the user. In some cases, image resources may require multiple intermediate network round-trips until the final image data can be retrieved. In some cases, video resources may also require multiple intermediate steps until the video stream is ready for presentation handling. The preview managers can monitor the overall states and conditions of the resources availability and dynamically present that information to the user.

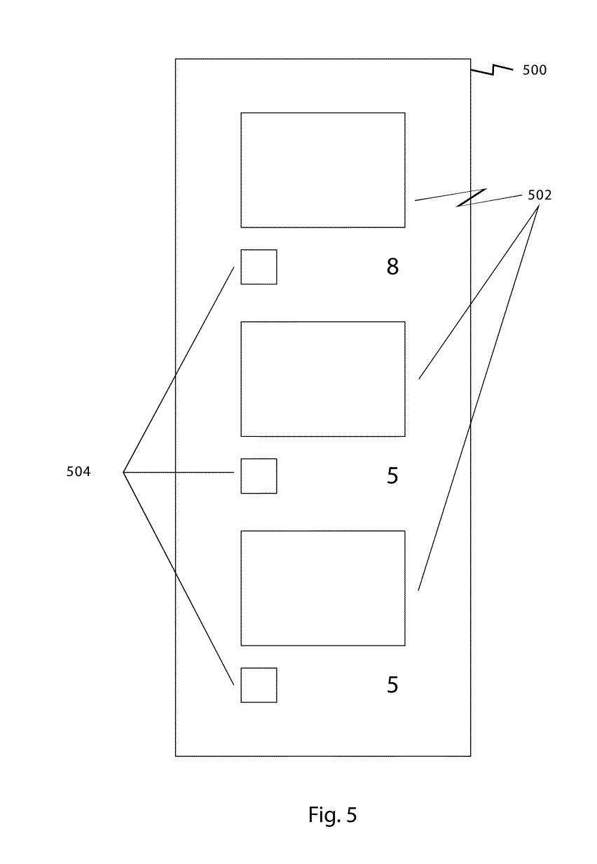

FIGS. 4a and 4b illustrate exemplary screen shots on client device 105, according to an embodiment of the disclosure. In this embodiment, the client device 105 can be a tablet PC (e.g., iPad). A software application for viewing content can be loaded and run on the client device. In various embodiments, the software application can be, for example, a mobile app installed on a mobile device or a full scale application installed on a PC or Mac. The software application can be a stand-alone application or a browser-based application. FIG. 4a illustrates an exemplary main screen 400 of the application. The screen 400 can display a 3×3 matrix of preview slots on the screen. It should be understood that the matrix layout is merely an exemplary layout. Other embodiments can show a matrix with a different size or a completely different arrangement of the preview slots. The layout can also be shown in any orientation supported by the client device. Additional channels can be displayed by, for example, scrolling the screen up, down, left, or right.

As shown in FIG. 4a, the top row of the matrix can include preview slots 402, 403, 404. Each of these preview slots can display a visual resource such as a video clip or a static image representing the content of a corresponding channel (or content source). For example, preview slot 402 can correspond to the Disney Channel, preview slot 403 can correspond to Reddit Videos, and preview slot 404 can correspond to content originated from the host server (e.g., server 100 of FIG. 1). The visual resource being displayed in each of preview slots can be in different format, as determined by the preview manager. For example, when the application is first launched on the device, resources can be in an unknown state. Thus, each of preview slots 402, 403, 404 can display a static image representing the corresponding channel/video source. The static image can be a logo representing the channel or the last image displayed from a previous viewing session. The logo or last image can be stored or cached in the device locally so that they can be displayed regardless of, for example, how much network bandwidth is available to the channel. The images can also be retrieved from the server. Alternatively, the preview slots 402, 403, 404 can simply be lift blank.

As the preview manager determines the availability of the channel and/or the hardware resources available to each channel (e.g., the bandwidth available to the channel provider), it can dynamically update the corresponding preview slot on the screen 400. For example, as the resources become more available to the Disney Channel, the corresponding preview slot 402 can replace the Disney logo with a series of images such as frames from the show being streamed to the device. The series of images can be repeated until when enough resources are available for the device to start receiving the actual streaming video. The resources accessible to each channel can vary. For example, Disney may have more bandwidth available for streaming its shows than Reddit. Additionally or alternatively, the content being received in each channel can be of different sizes. As such, one preview slot can already be streaming a video clip while another preview slot still displays the logo of its channel. As such, the individual preview slots can be updated asynchronously. This can create what is referred to in this document as the matrix effect.

In other words, the matrix effect is a visual interface style that can represent the various states and contents of channels, as determined and controlled by the preview manager. Channels can contain various items. And through the use of periodic updates, various forms of visual resources can be loaded by the preview manager in order to present the user with a dynamic informative overview of available content. As discussed above, not every channel is necessarily previewing. The preview manager can maintain and recycle a queue of available hardware resources that can be utilized for the matrix effect.

The user of the device can interact with the various channels after the application is initialized. Regardless of the visual resource being displayed in each preview slots 402, 403, 404, the application can launch a particular channel in response to a user selecting one of the preview slots.

Referring back to FIG. 4a, in addition to the preview slots, screen 400 can also display, for example, an avatar image associated with each channel and of the number of programs/video clips available on the channel. For example, a Disney avatar 405 and the number of available Disney shows (e.g., 5) can be displayed below the preview slot 402 assigned to the Disney Channel. Similarly, a Reddit avatar 407 and an Avatar of the host server can be displayed below the corresponding preview slots. The avatars can be downloaded from the respective channel. Before the download is complete, a placeholder image can be shown in place of the actual avatar. The placeholder image can be stored locally on the client device. It should be understood that any visual items other than previews and avatars can also be displayed on the client device using the matrix effect described herein.

After a user selects one of the channels by, for example, touching (or clicking) on the preview slot associated with the channel, screen 401 of FIG. 4b can be displayed on the client device. On screen 401, the content of the selected channel can be shown in, for example, the primary slot 410 on screen 401. Other available content on the same channel can be previewed in other slots 414. Optionally, other information such as user comments 412 can also be displayed on the same screen.

FIG. 5 illustrates an alternative representation to the matrix layout. The screen 500 shown in FIG. 5 can be a screen displayed on a smartphone (e.g., iPhone). Instead of a 3×3 matrix, the screen can include a column of three preview slots 502. The matrix effect can be adopted on this screen in that the three preview slots can be updated individually and asynchronously based on the resources available to the corresponding channels. Each of the preview slots 502 can also be associated with an avatar 504, which can also be loaded dynamically from a server. It should be understood that the layouts of FIGS. 4a and 5 are exemplary and that the same matrix effect can be applied to any other layout for displaying channel previews.

The above-described systems and methods of dynamically managing and presenting visual resources are not limited to the device display. Remote displays can be a natural presentation target given their larger resolutions and more centralized and visually sharable location. The matrix presentation can be targeted at intermediary devices such as Roku, Apple TV, Chromecast, Amazon Fire, and even TVs with embedded capabilities. In cases of a remote display, the actual device display can become a smart remote control for managing, controlling, and interacting with content on the remote display. Instead of a standard static remote, the device display can present a dynamic, context aware, interactive user interface for the remote display.

In other embodiments, the systems and methods disclosed above can be applied to presenting advertisements instead of or in addition to content. Traditional mobile advertising is based on limited matching criteria, if any, such as keywords chosen by advertising clients with relevant ad space. Given the flexibility of the systems disclosed herein in terms of presentation and supportable content, the channels can provide a more engaging experience while being less intrusive than standard mediums such as banners or interstitial ads. Instead of being separated from the user interface like most advertisements, the channels (and their corresponding preview slots on the screen) are displayed inline and visually harmonious with all of the other user's channels. Based on the advertiser's needs, channels can be prioritized in spatial terms or temporal frequency. Advertising channels can be selected based on the user's history or relevancy to the user's current context. Advertising elements can be inserted inside channels as well, appearing in-line with the normal channel contents.

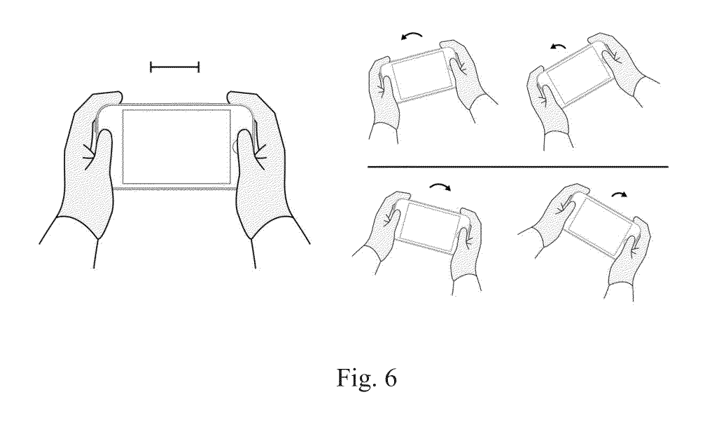

In another aspect of the disclosure, while watching video, a user may tilt the device in any direction 360° as shown in FIG. 6 to create an immersive virtual reality viewing experience. This allows the user to adjust their point of view in real time. The user may also navigate the user interface on the main landing page by panning their device to initiate spherical scrolling of all available channels and pinching to zoom in or out to view more or less channels. The software interacts with the accelerometer inside the hardware to determine the viewer's vantage point and uses input gestures by the user for further scrolling input.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A method for presenting content for a plurality of channels on a screen of a device comprising:
determining whether or not each of the plurality of channels is available for preview;
determining an available resource for each of the plurality of channels;
selecting a less resource-intensive visual item for display for each of the plurality of channels until the channel becomes available for preview and the available resource assigned to the channel is above a threshold; and
replacing the less resource-intensive visual item with a resource intensive visual item.

2. The method of claim 1, wherein the resource can be a network bandwidth.

3. The method of claim 1, wherein the less resource-intensive visual item can be an image or a series of discontinued images.

4. The method of claim 3, wherein the image can be a logo associated with the channel.

5. The method of claim 1, wherein the less resource-intensive visual item of one of the plurality of channels is displayed at the same time that the resource-intensive visual item of another of the plurality of channels is displayed.

6. The method of claim 1, wherein the resource-intensive visual item is a video clip.

7. The method of claim 6, wherein the video clip is a preview of content provided by the corresponding channel.

8. The method of displaying visual resources on a screen, comprising:
initializing an application to display a main screen comprising a plurality of preview slots;
displaying a static image in each of the plurality of preview slots, each static image associated with a corresponding channel;
receiving video previews from the channels in an asynchronous fashion; and
updating the static images with corresponding video previews in the plurality of preview slots as the video previews are received,
wherein at least on preview slot is displaying a static image while another preview slot is simultaneously displaying a video preview.

9. The method of claim 8, wherein the plurality of preview slots are arranged in a matrix.

10. The method of claim 8, wherein the static image is stored locally.

11. The method of claim 8, wherein at least two of the plurality of channels are provided by different content providers.

12. A system comprising:
a processor;
a network interface in communication with the processor and connecting the system to a client device;
a storage device in communication with the processor and storing a program which, when executed by the processor, performs the steps of:
determining whether or not each of the plurality of channels is available for preview;
determining an available resource for each of the plurality of channels;
selecting a less resource-intensive visual item for display for each of the plurality of channels until the channel becomes available for preview and the available resource assigned to the channel is above a threshold; and
replacing the less resource-intensive visual item with a resource intensive visual item.

13. The system of claim 12, wherein the resource can be a network bandwidth.

14. The system of claim 12, wherein the less resource-intensive visual item can be an image or a series of discontinued images.

15. The system of claim 14, wherein the image can be a logo associated with the channel.

16. The system of claim 12, wherein the less resource-intensive visual item of one of the plurality of channels is displayed at the same time that the resource-intensive visual item of another of the plurality of channels is displayed.

17. The system of claim 12, wherein the resource-intensive visual item is a video clip.

18. The system of claim 17, wherein the video clip is a preview of content provided by the corresponding channel.
